(19) United States
(12) Patent Application Publication
(10) Pub. No.: US 2024/0406495 A1
(43) Pub. Date: Dec. 5, 2024

(54) Method for managing the rendering of an item of audio content

(71) Applicant: ORANGE, Issy-les-Moulineaux (FR)

(72) Inventors: Mathieu Rivoalen, CHATILLON CEDEX (FR); Hervé Marchand, CHATILLON CEDEX (FR)

(21) Appl. No.: 18/697,247

(22) PCT Filed: Sep. 8, 2022
(86) PCT No.: PCT/FR2022/051696

§ 371 Date: Mar. 29, 2024

(30) Foreign Application Priority Data
Sep. 30, 2021 (FR) 2110316

(51) Int. Cl. H04N 21/439; H04N 21/2662; H04N 21/438; H04N 21/442

(52) U.S. Cl. CPC H04N 21/4398; H04N 21/2662; H04N 21/438; H04N 21/4424

(57) ABSTRACT

A method, performed by a management entity, for managing audio rendering of an item of audio content on a rendering device connected to a receiver device able to receive items of content from a content server. The item of audio content has a corresponding plurality of selectable audio tracks. The management entity performs the following steps: obtaining the audio decoding capabilities of the rendering device; requesting access to an item of multimedia content, made to the content server; and receiving an audio stream adapted to the audio decoding capabilities and of transmitting the audio stream to the rendering device.

### CROSS-REFERENCE TO RELATED APPLICATIONS

This Application is a Section 371 National Stage Application of International Application No. PCT/FR2022/051696, filed Sep. 8, 2022, and published as WO 2023/052703 on Apr. 6, 2023, not in English which claims priority to and the benefit of French Patent Application No. FR 2110316, filed Sep. 30, 2021, the contents of which are incorporated herein by reference in their entireties.

### TECHNICAL FIELD

The invention relates to the field of telecommunications.

The invention relates to a method for managing the rendering of an audio content by an audio rendering device linked to a stream receiving device via a communication link.

The invention targets the systems that include a receiving device connected via a communication link to at least one rendering device; the receiving device receives an audio content and transmits this audio content to said at least one rendering device to be rendered thereon.

A stream-receiving device targets for example a reading device such as a digital television decoder, a game console, et cetera.

A rendering device targets terminals capable of rendering a content including audio streams. Such a rendering device is equipped with an audio decoder of a given type. The rendering device is for example a television equipped with a speaker, a sound bar, a home cinema, et cetera.

The contents that are targeted include all contents including an audio track. The audio track can correspond to music or to the audio part of a video content.

The communication link targeted above can be any communication link. This link can be wired or wireless. It will be seen hereinbelow that, in the example of embodiment, the link chosen to illustrate the invention is a wired link of HDMI type.

### BACKGROUND

An audio content is generally encoded and requires a specific decoder to be rendered. The audio decoder can be located either in the reading device or in a rendering device linked to the reading device via a wired communication link (for example an HDMI link) or wireless communication link (for example a WI-Fi or Bluetooth link).

There are several types of audio coding that offer respective rendering qualities. This diversity of audio codings results in several types of audio streams and therefore of associated audio decoders. As examples, the types of audio coding that are best known are for example, from lowest quality to highest quality, Dolby stereo, Dolby DTS 5.1 format, Dolby TrueHD 7.1 format, et cetera.

A rendering of an audio content comprises several steps. An audio content server transmits the audio content to the reading device. After reception, the reading device transmits the content to the rendering device or devices. When a reading terminal is inserted between a content server and one or more rendering devices, the content server does not know the types of decoders installed in the rendering device or devices connected to the reading device; the multimedia streams are therefore transmitted by the content server with a standard audio quality that can be decoded by all the rendering devices, so as to guarantee a rendering of the audio content. The solution adopted effectively ensures a rendering of the content; however, the choice of using a standard quality offers an audio quality which is not satisfactory even though the rendering device is perhaps capable of rendering with a higher quality. The user experience is therefore not optimal.

### SUMMARY

An exemplary embodiment of the invention relates to a method for managing, by a management entity, the audio rendering on a rendering device connected to a receiving device for multimedia streams from a server capable of transmitting an audio content to a receiving device, characterized in that an audio content has several corresponding selectable audio tracks, the management entity performing the following steps:
a step of obtaining the audio decoding capabilities of the rendering device;
a step of requesting access to a multimedia content intended for the content server;
a step of receiving an audio stream matched to the audio decoding capabilities and of transmitting the audio stream to the rendering device.

According to the invention, the receiving device recovers a datum linked to the audio decoding capabilities of a rendering device to which it is connected; next, an audio track of a given quality can be selected from a set of audio tracks available for selection, the tracks offering respective rendering qualities.

The user experience is thus clearly enhanced compared to the state-of-the-art because the rendering device receives a coded audio stream which corresponds to the audio decoder with which it is equipped. More broadly, if several rendering devices are linked to the receiving device, the devices receive suitable audio streams. It is understood that the rendering devices can receive audio streams that are coded differently contrary to the state-of-the-art in which the streams received by the rendering devices are identical.

According to a first particular embodiment of the invention, the access request is followed by a step of reception of a file including at least one datum for access to a selectable audio track, of selection of at least one track matched to the capabilities and of requesting access to said at least one selected audio track. In this first embodiment, the management module recovers a file which will allow access directly to the desired audio streams. For example, in the case where the management entity is installed in the reading device, the latter will recover the types of decoders installed in the rendering devices if there are several thereof and request an access to the desired audio streams using the access data stored in the file.

According to a second particular embodiment of the invention, which will be able to be implemented alternatively or together with the preceding one, the access request includes a datum (DAT) representative of an audio decoding capability of the rendering device. In this second embodiment, it is the content server which receives the decoding capabilities obtained in the obtaining step and which is responsible for selecting the tracks and therefore the audio streams to be transmitted to the reading device.

According to a variant of the second embodiment, when several rendering devices are connected to the receiving device, the rendering devices having respective decoding capabilities, the datum (DAT) includes all or part of the capabilities obtained in the obtaining step. This variant offers the possibility of providing several capabilities and of receiving in return several types of audio streams.

According to a third embodiment of the invention, which will be able to be implemented alternatively or together with the preceding ones, the content includes a video part and an audio part, in that the video content is received in the form of video segments available according to several possible representations, in that the selected audio track varies in time according to the representation chosen for the video part. This third embodiment targets audio/video contents and makes it possible to select an audio quality by taking into account the representation chosen for the video part.

Remember also that a representation of a content or of a segment targets a given bit rate (expressed in kb/s) of the content or of the segment.

According to a fourth embodiment of the invention, which will be able to be implemented alternatively or together with the preceding ones, a priority is defined beforehand so as to prioritize a quality of the audio part rather than the video part, or vice versa, and in that the quality chosen for the priority part is the maximum possible quality. This embodiment makes it possible to prioritize an audio or video part and be assured that the maximum quality will be selected automatically for this priority part.

The maximum possible quality targets the track offering the best quality. According to a variant of this fourth embodiment, a bandwidth varies on the link linking the reading terminal and the server; the maximum possible quality can also be is dependent on the bandwidth available between the reading terminal and the server which supplies the content. This variant specifies that the maximum quality is not necessarily the maximum quality proposed for selection. This variant takes account of the current bandwidth to determine the maximum quality that it is possible to request to ensure a continuous, uninterrupted rendering quality. For example, if three audio qualities (Q1 to Q3 from lowest to highest) are accessible and the current bandwidth allows a reception of the lowest two, the maximum quality will correspond to the quality Q2.

According to a hardware aspect, the invention relates to an entity for managing the audio rendering of an audio content on a rendering device connected to a receiving device capable of receiving contents from a content server, characterized in that an audio content has several corresponding selectable audio tracks, the management entity comprising:
An obtaining module capable of obtaining audio decoding capabilities of the rendering device;
An access request module capable of requesting an access to a multimedia content intended for the content server;
A reception module capable of receiving an audio stream matched to the capabilities for audio decoding and transmission of the audio stream to the rendering device.

According to another hardware aspect, the invention deals with a device characterized in that it comprises a management entity as defined above.

According to another hardware aspect, the invention deals with a computer program capable of being implemented in a management entity as defined above, said program comprising code instructions which, when the program is run, performs the step defined in the method defined above.

According to another hardware aspect, the invention deals with a data processor-readable storage medium on which is stored a program comprising program code instructions for the execution of the steps of the method defined above.

It is specified here that the data medium can be any entity or device capable of storing the program. For example, the medium can comprise a storage means, such as a ROM, for example a CD ROM or a microelectronic circuit ROM, or even a magnetic storage means, or a hard disk. Also, the information medium can be a transmissible medium such as an electrical or optical signal, which can be routed via an electrical or optical cable, wirelessly or by other means.

The program according to the invention can in particular be downloaded over a network of Internet type. Alternatively, the information medium can be an integrated circuit in which the program is incorporated, the circuit being adapted to execute or to be used in the execution of the method concerned.

### BRIEF DESCRIPTION OF THE DRAWINGS

The invention will be better understood on reading the following description, given by way of example and with reference to the attached drawings in which:

FIG. 1 represents a computing system on which is illustrated an example of implementation of the invention in which the first device is a digital television coder and the second device is a rendering device.

FIG. 2 is a schematic view of the circuits present in the rendering device.

FIG. 3 is an algorithm illustrating a series of steps implemented according to a first possible embodiment of the invention in which the content accessed is an exclusively audio content.

FIG. 4 is an algorithm illustrating a series of steps implemented according to a second possible embodiment of the invention in which the content accessed is an audio and video content, the video part being downloaded in adaptive download (adaptive streaming) mode.

FIG. 5 is a schematic view of a content comprising segments of different qualities according to the adaptive streaming technique known to the person skilled in the art.

### DETAILED DESCRIPTION OF AN EXEMPLARY EMBODIMENT ILLUSTRATING THE INVENTION

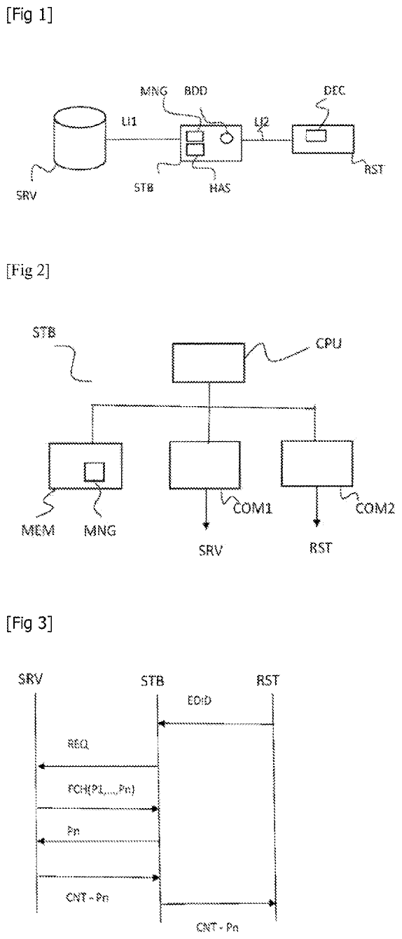

FIG. 1 represents a system SYS comprising a server SRV that can store audio and/or video contents. The audio contents target without preference audio contents include in multimedia contents or in exclusively audio contents such as music.

The system SYS comprises a receiving device STB for receiving audio and/or video streams. In our example, the receiving device is a decoder. Remember that a decoder is an adapter transforming an external signal from a communication network such as the Internet network into a content and displaying this content on a rendering device.

The system SYS further comprises a rendering device RST for rendering the audio stream received by the receiving device. The rendering device is, without preference, a television equipped with speakers, a sound bar, et cetera.

When several rendering devices are used, the devices are generally equipped with respective audio decoders.

The types of decoders vary and offer a sound rendering quality that is dependent on the type of audio decoder used. The type of audio decoder often refers to a standard; the known standards are for example the Dolby Stereo or DTS 5.1 or TrueHD7.1 and other such standards. It is specified here that “5.1”, “7.1” indicate the number of channels contained in an audio track. The first digit indicates the number of speakers. The second digit, placed after the “.”, 1 or 0, indicates the presence or not in the encoding, of a track dedicated to the subwoofer. The following designations are thus to be understood in this way; 1.0 means that the rendering device comprises a single central speaker for a necessarily monophonic sound; 5.0 means that the rendering device comprises a front left speaker, a central speaker, a front right speaker, and two “surround” speakers.

The different audio stream encoding standards can be organized hierarchically and therefore ranked according to the sound quality that they are capable of providing. A given quality requires a more or less high bit rate (the unit of which is kbps, for kilobits per second). As examples, an audio stream of “Dolby” type requires a bit rate of the order of 384 kbps (Stereo); a stream of “Dolby Digital plus” type requires a bit rate of the order of 768 kbps (used for streaming) or 1536 kbps (blu-ray discs); a stream of Dolby TrueHD type is of the order of 18 Mbps.

The server SRV is linked to the receiving device STB via any first communication link LI1. Similarly, the receiving device STB is linked to the rendering device via a second communication link LI2.

It should be noted that the receiving device can be linked to a home gateway (not represented). In this case, the streams originating from the decoder or those from the server transit through the home gateway. The bandwidth of the link LI1 between the server and the home gateway is generally evaluated.

The type of audio stream will therefore have an influence on the bandwidth associated with the link LI1.

The communication links LI1 and LI2 are able to convey an audio stream. In our example, the first link LI1 is the Internet network and the second link is a wired link such as an HDMI cable.

Referring to FIG. 2, the receiving device STB comprises a data processing module CPU (of processor or microcontroller type), a memory MEM (Flash for example), a first communication module for the communication with the first link LI1 and a second communication module for the communication with a the second communication link LI2.

The system SYS further comprises a management entity MNG implementing the method of the invention. In our example, the management entity MNG is stored in the memory MEM of the decoder receiving device STB but could equally be located on a device other than the reading device STB. This management module MNG will be described in more detail hereinbelow.

For the implementation of the invention, a content is associated with several audio tracks associated with respective qualities. For example, if the audio content is music, several audio tracks are accessible for this music with respective qualities. Similarly, in the case of a video content, the video is associated with several selectable audio tracks. In our example, three tracks are proposed: a track P1 coded in Dolby Stereo, a track P2 coded in Dolby DTS 5.1 and a track P3 coded in Dolby TrueHD 7.1.

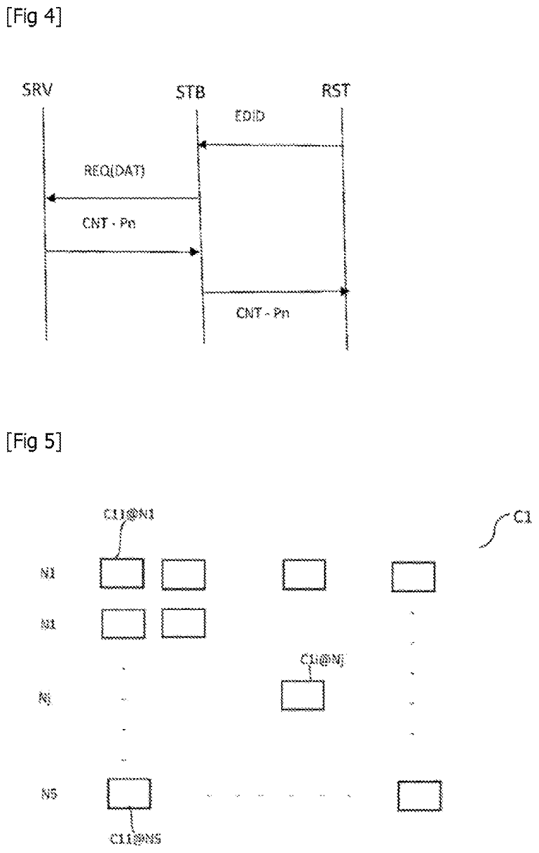

FIGS. 3 and 4 illustrate two embodiments in the form of exchanges of messages between the different entities of the computing system. In these figures, three axes are represented respectively associated with the server SRV storing tracks P1-Pn to be selected; with the decoder STB storing, in our example, the management entity MNG; and with the rendering device RST.

In these two embodiments, the rendering device RST is able to render a sound with a given quality (for example with a TrueHD quality).

FIG. 3 illustrates an embodiment in which the management entity recovers a file FCH (P1, . . . Pn) including access data for access to different audio tracks having different audio qualities. FIG. 4 illustrates, for its part, an embodiment in which the management entity MNG transmits to the content server data DAT representative of the decoding capabilities of the rendering device RST responsible for the server SRV for selecting the tracks most suited to the capabilities.

It should be noted that the two embodiments can be used alternatively or together.

Referring to FIG. 3, the steps relating to the first embodiment are as follows:

In our example, in a first preliminary phase, the management entity MNG recovers a datum EDID representative of the type of audio decoder present in the rendering device RST to which the decoder is connected. This example is limited to a single rendering device RST; however, the invention is not limited to a single rendering device but applies, on the contrary, to several rendering devices.

The recovery of the datum EDID can be performed in several ways depending on the type of the second link used LI2. In the case of an HDMI connection, the decoder STB can receive a datum EDID (acronym for “Extended Display Identification Data”) representative of the type of rendering device implied by the type of audio decoder DEC used. Next, an access to a database BDD storing correlations between data EDID and types of decoders make it possible to deduce the type or types of audio decoders used respectively.

Remember that, in the context of an HDMI link, the datum EDID is a metadatum supplied by a rendering device when the latter supplies its capabilities to a source device to which it is linked, here the decoder STB. In other words, when a television, a projector, et cetera, is connected by HDMI to a source device, an EDID is automatically transmitted by the rendering device RST and received by the source device STB.

By virtue of this datum EDID, the management entity MNG deduces, by virtue of the database, the type of audio decoder used using the database.

In a second phase, an access to an audio content is requested by the decoder STB; the steps of this second step are as follows:

In a first step, the decoder STB requests (REQ) an access to a multimedia content CNT.

In a second step, the server SRV downloads a file FCH(P1, P2, P3) comprising data representative of audio tracks P1-P3 available for the requested content. The representative data are for example Internet addresses allowing access to the tracks P1-P3, respectively. The Internet addresses identify the tracks concerned on a network. Such an address can be an identifier of URI (acronym for “Universal Resource Identifier”) type known to the person skilled in the art.

The decoder STB, knowing the audio decoder present on the rendering device RST, can select, in a third step, an audio track Pn (n is an integer, n=1-3) matched in the file (P1, P2, P3), for example the track P3, and request an access to the audio content by using the URL associated with the track P3 concerned. In our example, the track associated with the URL is stored on the server SRV.

The audio decoder DEC then receives, in a fourth step, the audio streams of the selected audio track and transmits them to the rendering device RST to be rendered thereon in a fifth step.

Reference is now made to FIG. 4; in this figure, the first step is the same as previously as that described with reference to FIG. 3.

In a second step, an access request REQ(DAT) including a datum DAT is transmitted by the decoder reading device STB to the server SRV. The datum DAT is a datum representative of the type of audio decoder DEC installed in the rendering device TST.

In a third step, following the reception of the datum DAT, the server SRV selects a track matched to the audio decoder DEC installed on the rendering device RST.

The server SRV then transmits to the decoder reading device STB, in a fourth step, the content CNT with an audio part Pn matched to the type of audio decoder DEC installed on the rendering device RST.

In a fifth step, the audio decoder DEC then receives the audio streams of the selected audio track and transmits them to the rendering device RST to be rendered thereon in a fifth step.

In a variant of the two preceding embodiments, in the case where no track P1 to P3 is compatible with the audio decoder, the server SRV transmits the content in a preferably non-coded format.

A few examples are described hereinbelow, and it is assumed in these examples that the first embodiment using a file FCH(P1, . . . , PN) is used.

In a first example, the decoder STB is linked to a Dolby Stereo-compatible television RST. The decoder recovers a datum representative of the type of audio decoder present in the television RST. In this example, the audio decoder DEC is Dolby Stereo-compatible. Following a request to access the content transmitted by the decoder STB, the server SRV downloads a file FCH(P1, . . . , P3) comprising the URLs of respective audio tracks P1-P3 available for the requested content. Knowing the audio decoder present on the television RST, the decoder can select a suitable audio track from among the available tracks P1-P3 described above. The decoder STB transmits to the server SRV a request to access the Dolby Stereo track P1. The server then transmits to the decoder STB the requested track P1, namely the Dolby Stereo audio track; the decoder STB then transmits the audio stream to the television RST.

In a second example, the decoder STB is linked to a DTS 5.1-compatible home cinema. The decoder STB recovers a datum representative of the type of audio decoder present in the home cinema. In this example, the audio decoder is DTS 5.1-compatible. Following a request to access the content transmitted by the decoder STB, the server SRV downloads a file FCH(P1, . . . , P3) comprising the audio tracks P1-P3 available for the requested content. Knowing the audio decoder present in the Home Cinema, the decoder STB can select the suitable audio track from among the available tracks P1-P3 described above. The decoder STB transmits to the server SRV a request to access the track P2, namely DTS 5.1. The server then transmits to the decoder STB the track 2, namely the DTS 5.1 audio track. The decoder STB then transmits the audio stream to the television RST.

According to a variant, the current bandwidth and the bit rate associated with the selected audio stream are taken into account in the selection of the track in the file received. This variant will be described in more detail in a second embodiment hereinbelow.

As indicated previously, the invention is not limited to a system comprising a single rendering device RST but extends to the system comprising several rendering devices. For example, a television can be linked to several speakers of different types equipped with different audio decoders DEC.

The way the different types of audio decoders are taken into account will depend on the embodiment chosen, either that which corresponds to FIG. 3, or that which corresponds to FIG. 4.

If the method used is that described with reference to FIG. 3, the decoder STB identifies the different types of decoders. Next, knowing the types of audio decoders present on the rendering devices RST, the decoder STB can select suitable audio tracks and request an access to the audio tracks by using the URLs associated with the tracks concerned.

Following the reception of the audio streams, the decoder STB redirects the audio streams to the rendering devices according to the audio stream received and the type of audio decoder.

If the method used is that described with reference to FIG. 4, the decoder STB identifies the different types of decoders. Next, the decoder STB transmits to the server SRV the data DAT1-DATn representative of the different types of audio decoders identified.

The server SRV then receives the request including the data DAT and transmits URLs of associated audio tracks to the different types of audio decoders.

Following the reception of the audio streams, the decoder STB redirects the audio streams received to the rendering devices according to the audio stream received and the type of audio decoder.

A third embodiment will now be described with reference to FIG. 5, and this third embodiment can be used together with or alternatively to the two first embodiments. In this third embodiment, the content is an audio/video content and the video part is a content broadcast in adaptive streaming mode.

In this embodiment, two contents, one video and the other audio, will be downloaded and each content requires a selection of a given quality.

Conventionally, as will be seen with reference to FIG. 3, in the adaptive streaming mode, different qualities can be encoded for the same content of a television channel, corresponding for example to different encoding bit rates. More generally, the term quality is used to refer to a certain resolution of the digital content (spatial and temporal resolution, quality level associated with the video and/or audio compression) with a certain encoding bit rate. Each quality level is itself subdivided on the content server into temporal segments (or “chunks”, these words being used without preference throughout this document).

The description of these different qualities and of the associated temporal segmentation, as well as the content segments, is accessible by the reading terminal STB and made available to it via their Internet addresses. The Internet addresses identify segments on a network. Such an address can be an identifier of URI (acronym for “Universal Resource Identifier”) type known to the person skilled in the art. All of these parameters (qualities, addresses of the segments, et cetera) are generally grouped together in a parameter file, called description file or “manifest MNF”. It will be noted that this parameter file can be a computing file or a set of information descriptive of the content, accessible at a certain address.

In a progressive adaptive downloading context, the terminal STB can adapt its requests to receive and decode the content requested by the user to the quality which best corresponds to it. For example, in considering a content available with the following three qualities 416 kb/s (kilobits per second), 680 kb/s (N2), and 1200 kb/s (N3) and in assuming that the reading terminal STB has a bandwidth of 5000 kb/s, in this configuration, the reading terminal DEC can request the content at any bit rate lower than this limit, for example 1200 kb/s.

Generally, with reference to FIG. 5, “Ci@Nj” is used to denote the content number i with the quality Nj (for example the jth quality level Nj described in the description file).

The number of encoding bit rates available per segment varies according to the reading terminal used. In FIG. 5, for example, a main content Cl comprises five available encoding bit rates N1-N5.

In our example, the system further comprises an encoder and a manifest generator. The encoder and the generator are not represented in the figures because they are of no interest in the explanation of the invention.

The role of the encoder is to encode a digital content in order to obtain several segments and several representations for each segment.

The encoded content is transmitted to the manifest generator which generates URI addresses for each segment created.

In the example illustrated, the encoder and the manifest generator are located in the server SRV which can be a referenced content provider.

In our example, the reading terminal STB can enter into communication with the content server SRV to receive one or more contents (films, documentaries, advertising clips, et cetera).

In our example, to view a content, the terminal STB obtains an address of the description file MNF of a desired main content (for example, Cl). Hereinbelow, it will be assumed that this file is a file of manifest type according to the MPEG-DASH standard and reference will be made, without preference according to the context, to the expression “description file” or “manifest”.

Once the reading terminal DEC has the segment addresses corresponding to the desired content, the decoding terminal STB proceeds to obtain segments via a download at these addresses. It will be noted that this downloading is done here, traditionally, through an HTTP URL, but could also be done through a universal address (URI) describing another protocol (dvb://monsegmentdecontenu for example).

When the decoder DEC receives the segments, the segments are then rendered on the screen of the rendering device RST.

To the choice of the representations of the segments for the video part is added the choice of the associated accessible audio tracks, themselves with respective qualities.

The choice of the representation chosen for a segment and the choice of a quality chosen for the audio part should be performed shrewdly so as to ensure both video and audio rendering quality. Indeed, the qualities selected over time, for the video part and for the audio part, will inevitably have an effect on the bandwidth on the link LI1.

According to a first variant, a representation of a segment is selected for the video part in the manner explained above. A calculation of bandwidth remaining on the link LI1 is performed, the latter taking into account the bit rate of the videos segment selected for the download and possibly other streams quite unrelated to the video content. Following the choice, a track is selected according to the bit rate (kbps/s) of the audio stream and of the remaining bandwidth. More specifically, the bit rate of the audio stream chosen is less than the remaining bandwidth.

According to a second variant, the audio quality can be prioritized. In this case, contrary to the first variant, a calculation of bandwidth remaining on the link LI1 is performed, the latter taking into account the maximum bit rate of the track offering a maximal quality. Following the choice, a segment representation is selected as a function of the remaining bandwidth taking into account the bit rate of the selected audio stream.

According to a third variant, a priority between a video or audio quality is defined beforehand. This prior step for example allows a user to define a preference of an audio quality over a video quality, or vice versa. Assume for example that the audio quality is prioritized over a video quality; this case can occur for a particular type of content; for example, if the content is a concert, the audio mode can be prioritized over the video part. In this case, if the available bandwidth is sufficient, the maximum audio quality P3 is selected. The module HAS charged with selecting a representation quality for the future segment reduces the quality selected by subtracting the chosen quality of the segment selected by the module HAS by the bit rate of the selected audio track P3.

A given bit rate results from the subtraction. The module HAS selects, from the list of the bit rates available for the video segment, a bit rate directly lower than the calculated start resulting from the subtraction.

The above mode is only an example. It is well understood that the priority could have been given to the segments of the video part rather than the audio tracks. In this configuration, the chosen audio quality is a quality chosen from among the lowest. In our example, the chosen audio quality is the minimum quality corresponding to the track P1.

It is detailed here finally that the management entity MNG comprises, for the implementation of the invention: An obtaining module capable of obtaining audio decoding capabilities of the rendering device;
An access request module capable of requesting an access to a multimedia content intended for the content server;
A reception module capable of receiving an audio stream matched to the capabilities for audio decoding and transmission of the audio stream to the rendering device.

It is finally noted here that, in the present text, the term “module” or “entity” can correspond equally to a software component and to a hardware component or to a set of hardware and software components, a software component corresponding itself to one or more computer programs or sub-programs or, more generally, to any element of a program capable of implementing a function or a set of functions as described for the modules concerned. Likewise, a hardware component corresponds to any element of a hardware set (or simply hardware) capable of implementing a function or a set of functions for the module concerned (integrated circuit, chip card, memory card, et cetera).

Although the present disclosure has been described with reference to one or more examples, workers skilled in the art will recognize that changes may be made in form and detail without departing from the scope of the disclosure and/or the appended claims.

1. A management method comprising:
managing, by a management entity, audio rendering of an audio content on a rendering device connected to a receiving device capable of receiving contents from a content server, wherein the audio content has several corresponding selectable audio tracks and the management entity performs the following:
obtaining an audio decoding capabilities of the rendering device;
requesting access to a multimedia content intended for the content server;
receiving an audio stream matched to the audio decoding capabilities; and
transmitting the audio stream to the rendering device.

2. The management method as claimed in claim 1, wherein the access request is followed by receiving a file including at least one datum for access to at least one of the selectable audio tracks, selecting at least one track of the several corresponding selectable audio tracks, which is matched to the audio decoding capabilities, and requesting access to said selected at least one track.

3. The management method as claimed in claim 1, wherein the access request includes a datum representative of the audio decoding capabilities of the rendering device.

4. The management method as claimed in claim 4, wherein, when several rendering devices are connected to the receiving device, the rendering devices having respective decoding capabilities, the datum includes all or part of the obtained audio decoding capabilities.

5. The management method as claimed in claim 1, wherein the content includes a video part and an audio part, wherein the video content is received in the form of video segments available according to several possible representations, and the selected audio track varies in time according to a representation chosen for the video part.

6. The management method as claimed in claim 1, wherein the content includes a video part and an audio part and a priority is defined beforehand so as to prioritize a quality of the audio part rather than the video part, or vice versa, and wherein the quality chosen for the audio part is a maximum possible quality.

7. The management method as claimed in claim 6, wherein a bandwidth varies on a link linking the receiving device and the content server, and wherein the maximum possible quality is dependent on a bandwidth available between the receiving device and the content server.

8. A management entity comprising:
at least one processor;
at least one non-transitory computer readable medium comprising instructions stored thereon which when executed by the at least one processor configure the management entity to manage audio rendering of an audio content on a rendering device connected to a receiving device capable of receiving contents from a content server, wherein the audio content has several corresponding selectable audio tracks, the managing comprising:
obtaining audio decoding capabilities of the rendering device;
requesting an access to a multimedia content intended for the content server;
receiving an audio stream matched to the audio decoding capabilities; and
transmitting the audio stream to the rendering device.

9. A device which comprises the management entity as defined in claim 8.

10. (canceled)

11. A non-transitory computer readable storage medium on which is stored a program comprising program code instructions for execution of a method of managing audio rendering of an audio content on a rendering device, when the instructions are executed by a processor of a management entity, wherein the rendering device is connected to a receiving device capable of receiving contents from a content server, the audio content has several corresponding selectable audio tracks, and the method comprises:
obtaining an audio decoding capabilities of the rendering device;
requesting access to a multimedia content intended for the content server;
receiving an audio stream matched to the audio decoding capabilities; and
transmitting the audio stream to the rendering device.
